(19) United States
(12) Patent Application Publication
(10) Pub. No.: US 2019/0197906 A1
(43) Pub. Date: Jun. 27, 2019

(54) Automatic Method And System For Aiding In The Piloting Of An Aircraft

(71) Applicant: Airbus Operations S.A.S., Toulouse (FR)

(72) Inventors: Thierry Bourret, Toulouse (FR); Matthieu Barba, La Salvetat (FR); Maxime Semat, Toulouse (FR); Florent Lanterna, Beauzelle (FR); Didier Sauve, Blagnac (FR)

(73) Assignee: Airbus Operations S.A.S., Toulouse (FR)

(21) Appl. No.: 16/209,201

(22) Filed: Dec. 4, 2018

(30) Foreign Application Priority Data
Dec. 21, 2017 (FR) 17 62839

(51) Int. Cl. G08G 5/00; G01C 23/00; G05D 1/10; G05D 1/00; G08G 5/02

(52) U.S. Cl. CPC G08G 5/0047; G01C 23/005; G05D 1/101; G08G 5/025; G08G 5/0073; G08G 5/0013; G05D 1/0077

(57) ABSTRACT

A piloting aid system for ensuring the availability an automatic pilot corresponding to an automatic piloting system and/or a flight director and/or a thrust regulation device to be controlled as a function of a speed information item determined from a source of information, and configured to operate according to a first current guidance mode and an approach capability that are part of a first set of guidance modes and approach capabilities. The system includes a surveillance module to be able to detect the loss of sources of information, a module for determining a second set of guidance modes and of approach capabilities as a function of the source or sources of information whose loss was detected by the surveillance module, a module for use, by the automatic pilot and/or the thrust regulation device, of a second current guidance mode and an approach capability that are part of the second set.

### FIELD OF THE INVENTION

The present invention relates to an automatic method and an automatic system for aiding in the piloting of an aircraft to control at least an automatic pilot and possibly a thrust regulation system of the aircraft.

### BACKGROUND OF THE INVENTION

In the context of the present description, an automatic pilot corresponds:
either to an automatic piloting system which acts automatically on the control surfaces of the aircraft to ensure the guidance thereof,
or to a flight director which automatically displays information on a screen of the cockpit of the aircraft in order to provide an aid to the manual piloting performed by the pilot of the aircraft.

It is known that the automatic pilot of an aircraft, when it is coupled or not to a thrust regulation device, uses an item of speed information in order to keep a selection of the pilot and/or the speed range to acceptable values for the aircraft. If, in the piloting, this item of speed information is lost, that is to say if it becomes unavailable, errored, or unreliable, the automatic pilot and/or the thrust regulation device are automatically disengaged while maintaining the current state of the aircraft (current attitude and thrust), and hand over control to the crew. Such a situation can occur, in particular, in the case of common mode of failures due, for example, to severe or degraded environmental conditions. This situation is however exceptional, because most aircraft are equipped with systems that make it possible to limit the effects of said environmental conditions, so as to improve the availability of the item of speed information. A disengagement of the automatic pilot and/or of the thrust regulation device induces an additional workload for the crew which has to deal with the cause of the failure in addition to the usual tasks, and do so in an unusual situation in which the item of speed information is lost. The speed information is a primary parameter, used by the automatic piloting system or the flight director, to define the flight envelope of the aircraft (high and low limits) and the dynamics of the aircraft. An automatic pilot or a thrust regulation device which might not observe these speed limits could cause the aircraft to depart from its flight envelope. For this reason, the automatic pilot and the thrust regulation device are provided with different standard means to protect the speed range.

The document FR 2 960 659 A1 proposes a solution which does not give full satisfaction. In fact, it induces limitations on the operational capabilities of the automatic pilot which increases the workload of the crew.

### BRIEF SUMMARY OF THE INVENTION

Aspects of the present invention may mitigate these drawbacks by proposing a piloting aid method and system embedded on an aircraft.

An aspect of the invention relates to an automatic method for aiding in the piloting of an aircraft, making it possible to ensure the availability of at least an automatic pilot and/or a thrust regulation device which can be controlled as a function of an item of aircraft speed information, the automatic pilot corresponding to an automatic piloting system and/or a flight director, the aircraft speed information item being determined from one or more sources of information, the automatic pilot and/or the thrust regulation device being configured to operate according to a first current guidance mode and an approach capability selected by a pilot of the aircraft included in a first set of selectable guidance modes and of selectable approach capabilities.

According to an aspect of the invention, the method comprises:
a surveillance step, implemented by a surveillance module, including being able to detect the loss of one or more of said one or more sources of information making it possible to determine the item of aircraft speed information;
   in case of detection of a loss of at least one source of information, the method comprising the following steps:
a first determination step, implemented by a determination module, including choosing a second predetermined set of selectable guidance modes and of selectable approach capabilities as a function of the information source or sources whose loss was detected in the surveillance step, the second set being a subset of the first set;
a first step of use, implemented by a using module, including making the automatic pilot and/or the thrust regulation device operate according to a second current guidance mode and an approach capability forming part of the second set.

Thus, the operational capabilities of the automatic pilot and of the thrust regulation device are maximized through the taking into account of all the parameters that remain available when the item of aircraft speed information is no longer available from the sources of information. The workload of the crew is consequently lightened.

According to a particular feature, the first set also comprises a first state machine configured to manage transitions to switch from one guidance mode out of the guidance modes of the first set to another guidance mode out of the guidance modes of the first set,

the first determination step also including determining a second state machine configured to manage transitions to switch from one guidance mode out of the guidance modes of the second set to another guidance mode out of the guidance modes of the second set.

According to another particular feature:
when the first current guidance mode forms part both of the first set and of the second set, there is no change of guidance mode;
when the first current guidance mode does not form part of the second set, there is a change of guidance mode to a predetermined guidance mode, forming part of the second set.

According to one embodiment, after the detection of a loss of at least one source of information, the surveillance step continues to be implemented by the surveillance module,
in case of detection of the end of loss of the source or sources of information in the surveillance step, the surveillance step is followed:
   by a second step of use, implemented by the using module, including making the automatic pilot and/or the thrust regulation device operate according to a current guidance mode and an approach capability forming part of the first set,
in case of the detection of the loss of at least one other source of information in the surveillance step, the surveillance step is followed:
   by a second determination step, implemented by the determination module, including modifying the second set of selectable guidance modes and of selectable approach capabilities as a function of the source or sources of information whose loss was detected in the surveillance step,
   a third step of use, implemented by the using module, including making the automatic pilot and/or the thrust regulation device operate according to a third current guidance mode and an approach capability included in the modified second set.

According to one embodiment, the sources of information surveyed in the surveillance step comprise at least one anemo-barometric sensor and at least one speed estimator.

Advantageously, the method comprises a backup step, implemented by a backup module, including determining an altitude and a vertical speed by using a source of auxiliary information comprising a geolocation device or an inertial unit associated with a geolocation device, the backup step being implemented if the loss of source of information consisting in the loss of the or all of the anemo-barometric sensors and of the speed estimator is detected in the surveillance step.

For example, the guidance modes are included among:
the following lateral guidance modes:
   a heading tracking mode,
   a route tracking mode,
   a flight plan-based navigation mode,
   an approach beam lateral capture mode,
   an approach beam lateral tracking mode,
   a virtual approach beam lateral capture mode of a navigation system of the aircraft,
   a virtual approach beam lateral tracking mode of the navigation system;
the following vertical guidance modes:
   a vertical speed holding mode,
   a flight plan angle holding mode,
   an altitude capture mode,
   an altitude maintaining mode,
   a post-take-off climb or go-around mode,
   a climb with constant thrust or speed maintaining mode,
   a descent with constant thrust or speed maintaining mode,
   a climbing vertical profile tracking mode,
   a descending vertical profile tracking mode,
   an air collision avoidance profile vertical tracking mode,
   an approach beam vertical capture mode,
   an approach beam vertical tracking mode,
   a virtual approach beam vertical capture mode of the navigation system,
   a virtual approach beam vertical tracking mode of the navigation system;
the following thrust regulation guidance modes:
   a speed maintaining mode,
   a Mach number maintaining mode,
   a thrust maintaining mode.

Furthermore, the approach capabilities classified according to a decision height and a runway visual range are included among:
a first approach capability for which the decision height is greater than or equal to 200 feet and for which the runway visual range is greater than or equal to 2400 feet,
a second approach capability for which the decision height is greater than or equal to 100 feet and strictly less than 200 feet and for which the runway visual range is greater than or equal to 1000 feet,
a third approach capability for which the decision height is strictly less than 100 feet and for which the runway visual range is greater than or equal to 700 feet,
a fourth approach capability for which the decision height is greater than or equal to zero and strictly less than 50 feet and for which the runway visual range is greater than or equal to 250 feet and strictly less than 700 feet,
a fifth approach capability for which the decision height and the runway visual range are nil.

According to an embodiment, the sources of information comprise three anemo-barometric sensors and a speed estimator, the first set comprising all the guidance modes and all the approach capabilities.

For example, in the case where the loss of an anemo-barometric sensor is detected in the surveillance step, the second set determined in the first determination step corresponds to the first set.

Furthermore, in the case where the loss of two anemo-barometric sensors is detected in the surveillance step, the second set determined in the first determination step comprises all the guidance modes of the first set and the first approach capability.

Furthermore, in the case where the loss of the three anemo-barometric sensors is detected, the second set determined in the first determination step comprises at least:
the heading tracking mode,
the route tracking mode,
the approach beam lateral capture mode,
the approach beam lateral tracking mode,
the vertical speed holding mode,
the flight path angle holding mode,
the altitude capture mode,
the altitude maintaining mode,
the post-take-off climb or go-around mode,
the climb with constant thrust or speed maintaining mode,
the descent with constant thrust or speed maintaining mode,
the approach beam vertical capture mode,
the approach beam vertical tracking mode,
all the thrust regulation guidance modes,
the first approach capability.

Moreover, in the case where the loss of the three anemo-barometric sensors and of the speed estimator is detected, the second set determined in the first determination step comprises at least:
the heading tracking mode,
the route tracking mode,
the vertical speed holding mode,
the flight path angle holding mode,
the thrust maintaining mode.

The invention relates also to an automatic system for aiding in the piloting of an aircraft, making it possible to ensure the availability of at least an automatic pilot and/or a thrust regulation device which can be controlled as a function of an item of aircraft speed information, the automatic pilot corresponding to an automatic piloting system and/or a flight director, the item of aircraft speed information being determined from one or more sources of information, the automatic pilot and/or the thrust regulation device being configured to operate according to a first current guidance mode and an approach capability selected by a crew of the aircraft included in a first set of selectable guidance modes and of selectable approach capabilities.

According to an embodiment of the invention, the system comprises:
a surveillance module configured to be able to detect the loss of one or more of said one or more sources of information making it possible to determine the speed of the aircraft;
   the system also comprising the following modules implemented in case of the detection of a loss of at least one source of information:
a determination module configured to choose a second predetermined set of selectable guidance modes and of selectable approach capabilities as a function of the source or sources of information whose loss was detected by the surveillance module, the second set being a subset of the first set,
a first using module configured to make the automatic pilot and/or the thrust regulation device operate according to a second current guidance mode and an approach capability included in the second set;
   the determination module and the first using module being implemented in case of the detection of a loss of at least one source of information.

The invention relates also to an aircraft, in particular a transport aeroplane, comprising a piloting aid system as described above.

### BRIEF DESCRIPTION OF THE DRAWINGS

The invention, with its features and advantages, will emerge more clearly on reading the description given with reference to the attached drawings in which:

FIG. 1 schematically represents the piloting aid system,

FIG. 2 schematically represents the piloting aid method,

FIG. 3 represents an aircraft with the piloting aid system embedded.

### DETAILED DESCRIPTION

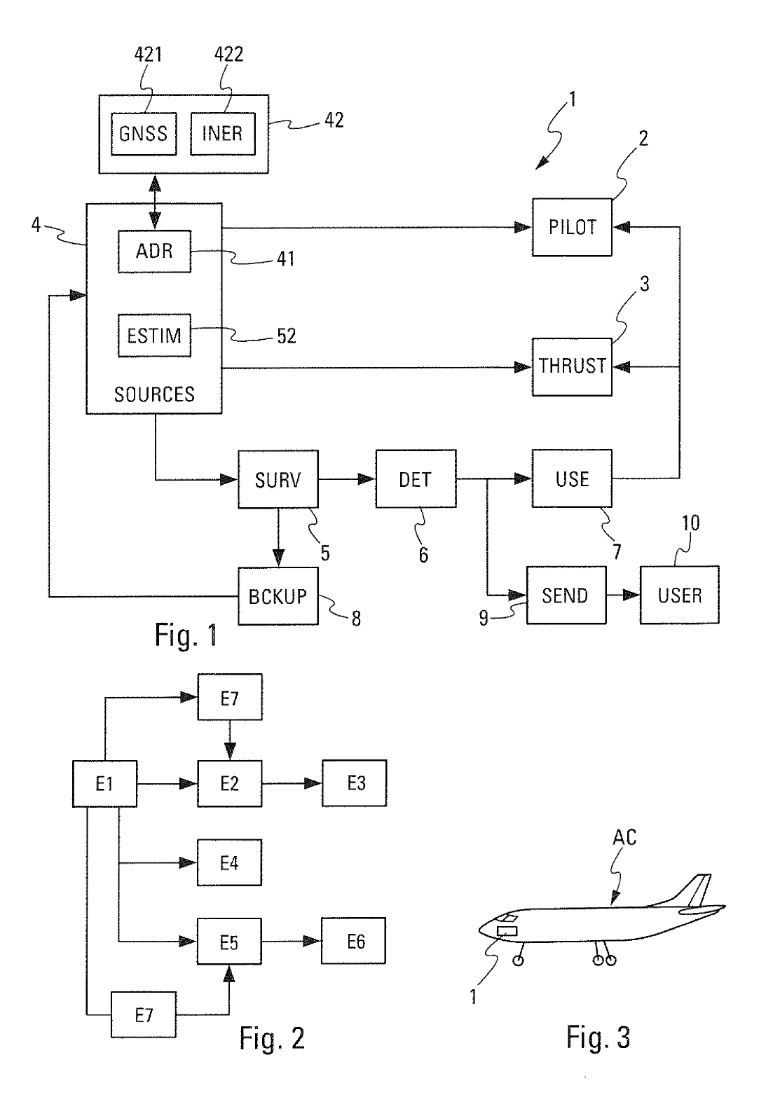

FIG. 1 schematically represents an embodiment of an automatic piloting aid system 1 embedded in an aircraft AC (FIG. 3).

The piloting aid system 1 makes it possible to ensure the availability of at least an automatic pilot PILOT (PILOT, for “automatic pilot”) 2 and/or a thrust regulation device THRUST (THRUST for “thrust regulation device”) 3 which can be controlled as a function of an item of speed information. The item of speed information is determined from at least one source of information SOURCES (SOURCES for “sources of information”) 4.

The automatic pilot 2 can correspond to an automatic piloting system which acts on control surfaces of the aircraft AC to ensure the guidance thereof and/or to a flight director which automatically displays information on a screen of the cockpit in order to provide an aid to the manual piloting performed by the pilot of the aircraft AC.

The automatic pilot 2 and/or the thrust regulation device 3 are configured to operate according to a first current guidance mode and an approach capability that are selected by a crew of the aircraft AC that are part of a first set of guidance modes that can be selected by the crew and of approach capabilities that can be selected by the crew.

According to one embodiment, the guidance modes are included among the lateral guidance modes, vertical guidance modes, thrust regulation guidance modes.

The table below lists an example of the main lateral, vertical and thrust regulation guidance modes.

Lateral guidance modes

| | |
|---|---|
| HDG | Heading tracking |
| TRK | Route tracking |
| NAV | Flight plan-based navigation |
| LOC* | Approach beam lateral capture |
| LOC | Approach beam lateral tracking |
| FLOC* | Virtual approach beam lateral capture of the navigation system |
| | of the aircraft |
| F-LOC | Virtual approach beam lateral tracking of the navigation |
| | system |

Vertical guidance modes

| | |
|---|---|
| VS | Vertical speed holding |
| FPA | Flight path angle holding |
| ALT* | Altitude capture |
| ALT | Altitude maintaining |
| SRS | Post-take-up climb or go-around |
| OP CLB | Climb with constant thrust or speed maintaining |
| OP DES | Descent with constant thrust or speed maintaining |
| CLB | Climbing vertical profile tracking |
| DES | Descending vertical profile tracking |
| TCAS | Air collision avoidance profile vertical tracking |
| G/S* | Approach beam vertical capture |
| G/S | Approach beam vertical tracking |
| F-G/S* | Virtual approach beam vertical capture of the navigation |
| | system |
| F-G/S | Virtual approach beam vertical tracking of the navigation |
| | system |

Thrust regulation guidance modes

| | |
|---|---|
| SPEED | Speed maintaining |
| MACH | Mach maintaining |
| THR | Thrust maintaining |

The lateral and vertical guidance modes are used to make the automatic pilot 2 operate. The thrust regulation guidance modes are used to make the thrust regulation device 3 operate.

There are several approach categories, otherwise referred to as approach capabilities, that are linked, for example, to an instrument landing system (ILS for “Instrument Landing System”), to a ground-based augmentation system (GLS for “GBAS Landing System”, GBAS for “Ground-Based Augmentation System”) and to a satellite-based augmentation system (SLS for “SBAS Landing System”, SBAS for “Satellite-Based Landing System”).

These approach categories correspond to approach possibilities for a landing on a landing runway.

The table below lists the minimal approach categories.

| | | Runway visual range |
|---|---|---|
| | Decision height (DH) | (RVR) |
| CAT I | DH ≥ 200 feet | RVR ≥ 2400 feet |
| | (≥61 m approx.) | (RVR ≥ 731.5 m approx.) |
| CAT II | 100 feet ≤ DH < 200 feet | RVR ≥ 1000 feet |
| | (30.5 m ≤ DH < 61 m approx.) | (RVR ≥ 305 m approx.) |
| CAT III A | DH < 100 feet | RVR ≥ 700 feet |
| | (DH < 30.5 m approx.) | (RVR ≥ 213.5 m approx.) |
| CAT III B | 0 < DH < 50 feet | 250 feet ≤ RVR ≤ |
| | (0 < DH < 15.25 m approx.) | 700 feet |
| | | (76 m ≤ RVR ≤ 213.5 m |
| | | approx.) |
| CAT III C | DH = 0 | RVR = 0 |

The decision height corresponds to the height at which the pilot of the aircraft AC decides whether the visual references regarding the runway are appropriate to continue the approach. If the appropriate visual references are not established, the pilot must perform a go-around. If the appropriate visual references are established, the pilot can continue the approach. However, the pilot may decide to execute a go-around if he or she judges the visual references to be degraded.

The runway visual range corresponds to a distance of visibility of the runway which is identified from surface markings or light signals delimiting the runway.

The piloting aid system comprises a surveillance module SURV (SURV for “surveillance module”) 5 configured to be able to detect the loss of one or more sources of information 4.

According to an embodiment, the sources of information 4 surveyed by the surveillance module 5 comprise at least one anemo-barometric sensor ADR (ADR for “air data reference”) 41 and at least one speed estimator ESTIM (ESTIM for “estimating module”) 52.

Advantageously, the piloting aid system 1 comprises a backup module BCKUP 8 which makes it possible to determine an altitude and a vertical speed by using a source of auxiliary information 42 comprising a GNSS geolocation device (GNSS for “Global Navigation Satellite System”) 421 or an inertial unit INER (INER for “inertial measurement unit”) 422 associated with a geolocation device 421. Said backup module 8 is implemented if the loss of sources of information consisting in the loss of or all of the anemo-barometric sensors 41 and of the speed estimator 52 is detected by the surveillance module 5. The geolocation device can comprise a satellite geo-navigation system such as a satellite geolocation system (GPS for “Global Positioning System”).

The piloting aid system 1 also comprises a determination module DET (DET for “determination module”) 6 and a using module USE (USE for “using module”) 7 which are implemented in case of the detection of a loss of at least one source of information 4.

The determination module 6 is configured to chose a second predetermined set of guidance modes that can be selected by the crew and of approach capabilities that can be selected by the crew as a function of the source or sources of information 4 whose loss has been detected by the surveillance module 5. The second set corresponds to a subset of the first set.

The using module 7 is configured to make the automatic pilot 2 and/or the thrust regulation device 3 operate according to a second current guidance mode and an approach capability that are part of the second set.

The automatic pilot 2 and the thrust regulation device 3 usually run on a standard state machine which makes it possible to manage the transitions between the guidance modes on request from the pilot.

Thus, according to a variant, the first set also comprises a first state machine configured to manage transitions to switch from one guidance mode out of the guidance modes of the first set to another guidance mode out of the guidance modes of the first set.

In this variant, the determination module 6 is also configured to determine a second state machine configured to manage transitions to switch from one guidance mode out of the guidance modes of the second set to another guidance mode out of the guidance modes of the second set.

Advantageously, when the first current guidance mode is part both of the first set and of the second set chosen by the determination module 6, there is no change of guidance mode. When the first current guidance mode is not part of the second set determined by the determination module 6, there is a change of guidance mode to a predetermined guidance mode, that is part of the second set. The predetermined guidance mode is a function of the sources of information 4 still available.

After the detection of a loss of at least one source of information 4 by the surveillance module 5, said surveillance module 5 can continue to detect the losses of sources of information 4.

Thus, in case of the detection of the end of loss of the source or sources of information 4 detected previously, the using module 7 allows the use by the automatic pilot 2 and/or the thrust regulation device 3 of a current guidance mode and an approach capability that are part of the first set.

Moreover, in case of the detection of loss of at least one other source of information, the determination module 6 makes it possible to modify the second set of selectable guidance modes and of selectable approach capabilities as a function of the source or sources of information 4 whose loss has been detected by the surveillance module 5. Furthermore, the using module 7 allows the use by the automatic pilot 2 and/or the thrust regulation device 3 of a third current guidance mode and an approach capability of the modified second set.

In a preferred embodiment, the sources of information 4 comprise three anemo-barometric sensors 41 and a speed estimator 52. The first set comprising all the guidance modes and all the approach capabilities available for the aircraft AC.

The embodiment described below implements the guidance modes and the approach capabilities listed in the previous tables. However, this embodiment can implement other guidance modes and other approach capabilities.

In the case where the loss of an anemo-barometric sensor 41 is detected by the surveillance module 5, the second set determined by the determination module 6 corresponds to the first set.

In the case where the loss of two anemo-barometric sensors 41 is detected by the surveillance module 5, the second set determined by the determination module 6 comprises all the guidance modes of the first set and the first approach capability CAT I.

In the case where the loss of the three anemo-barometric sensors 41 and of the speed estimator 52 is detected by the surveillance module 5, the backup module 8 is implemented in order to determine an altitude and a vertical speed by using a source of auxiliary information 42 comprising a geolocation device 421 or an inertial unit 422 associated with a geolocation device 421.

The second set then determined by the determination module 6 comprises at least:
the heading tracking mode HDG,
the route tracking mode TRK,
the approach beam lateral capture mode LOC*,
the approach beam lateral tracking mode LOC,
the vertical speed holding mode VS,
the flight path angle holding mode FPA,
the altitude capture mode ALT*,
the altitude maintaining mode ALT,
the post-take-off climb or go-around mode SRS,
the climb with constant thrust or speed maintaining mode OP CLB,
the descent with constant thrust or speed maintaining mode OP DES,
the approach beam vertical capture mode G/S*,
the approach beam vertical tracking mode G/S,
all the thrust regulation guidance modes SPEED, MACH, THR,
the first approach capability CAT I.

The flight plan-based navigation mode NAV, the virtual approach beam lateral capture mode of the navigation system F-LOC* and the virtual approach beam lateral tracking mode of the navigation system F-LOC are disengaged to be replaced by the heading tracking mode HDG or the route tracking mode TRK depending on whether the current flight reference is respectively heading holding or route holding. The climbing vertical profile tracking mode CLB, the descending vertical profile tracking mode DES, the virtual approach beam vertical capture mode of the navigation system G/S* and the virtual approach beam vertical tracking mode of the navigation system G/S are disengaged to be replaced by the vertical speed holding mode VS or the flight path angle holding mode FPA depending on whether the current flight reference is respectively vertical speed holding or flight path angle holding. The air collision avoidance profile vertical tracking mode TCAS is disengaged to be replaced by the vertical speed holding mode VS.

The lateral approach beam for guidance modes LOC and LOC* can correspond to a Localizer approach beam. The vertical approach beam for the guidance modes G/S and G/S* can correspond to a Glide approach beam.

The Localizer approach beam supplies a deviation of the aircraft AC relative to a runway axis. The Glide approach beam supplies a deviation relative to a nominal approach flight path angle.

In the case where the loss of the three anemo-barometric sensors 41 and of the speed estimator 52 is detected by the surveillance module 5, the second set determined by the determination module 6 comprises at least:
the heading tracking mode HDG,
the route tracking mode TRK,
the vertical speed holding mode VS,
the flight path angle holding mode FPA,
the thrust maintaining mode THR.

In an advantageous embodiment, upon the switchover from a barometric altitude reference (or barometric-inertial reference) of the GNSS system or of the GNSS system associated with an inertial unit (GNSS-inertial), the current altitude of the aircraft AC in each of the two references can differ by several thousands of feet. Mechanisms for reversals of guidance modes of the automatic pilot are put in place to manage the transition between these two references:
from barometric to GNSS-inertial;
from GNSS-inertial to barometric.

Thus, non-exhaustively:
the altitude capture mode ALT* or the altitude maintaining mode ALT is disengaged to be replaced by the vertical speed holding mode VS or the flight path angle holding mode FPA;
the climb with constant thrust mode OP CLB or the descent with constant thrust mode OP DES are disengaged to be replaced by the vertical speed holding mode VS or the flight path angle holding mode FPA, if the altitude setpoint is no longer, respectively, above or below the altitude of the aircraft AC in the new reference.

In another advantageous embodiment, alert messages are sent to the cockpit for each operational capability level, so as to indicate to the crew the remaining guidance modes and approach capabilities of the automatic pilot 2 and of the thrust regulation device 3. The messages can be sent by a sending module SEND (SEND for “sending module”) 9 which is configured to send a signal representative of the set of available guidance modes and of available approach capabilities available to a using device USER (USER for “user device”) 10. The sending module 9 can be included in the piloting aid system 1. The user device 10 can comprise a screen which is arranged to display the set of available guidance modes and of available approach capabilities.

The invention relates also to an automatic method for assisting in the piloting of an aircraft AC. Said method, represented schematically in FIG. 2, comprises:
a surveillance step E1, implemented by the surveillance module 5, including being able to detect the loss of one or more sources of information 4.

In case of the detection of a loss of at least one source of information 4, the method also comprises the following steps:
a determination step E2, implemented by the determination module 6, including choosing a second predetermined set of selectable guidance modes and of selectable approach capabilities as a function of the source or sources of information 4 whose loss was detected in the surveillance step E1,
a step E3 of use, implemented by the using module 7, including making the automatic pilot 2 and/or the thrust regulation device 3 operate according to a second current guidance mode and an approach capability that a part of the second set.

According to a variant, the determination step E2 also includes determining a second state machine configured to manage transitions for switching from one guidance mode out of the guidance modes of the second set to another guidance mode out of the guidance modes of the second set.

After the detection of a loss of at least one source of information 4, the surveillance step E1 can continue to be implemented by the surveillance module 5.

Thus, in case of the detection of the end of loss of the source or sources of information 4 in the surveillance step E1, the surveillance step E1 is followed:
by a step E4 of use, implemented by the using module 7, including making the automatic pilot 2 and/or the thrust regulation device 3 operate according to a current guidance mode and an approach capability included in the first set.

Furthermore, in case of the detection of loss of at least one other source of information 4 in the surveillance step E1, the surveillance step E1 is followed:
by a determination step E5, implemented by the determination module 6, including modifying the second set of selectable guidance modes and of selectable approach capabilities as a function of the source or sources of information 4 whose loss was detected in the surveillance step E1,
a step E6 of use, implemented by the using module 7, including making the automatic pilot 2 and/or the thrust regulation device 3 operate according to a third current guidance mode and an approach capability included in the modified second set.

Advantageously, the method comprises a backup step E7, implemented by the backup module 8, including determining an altitude and a vertical speed by using a source of auxiliary information 42 comprising a geolocation device 421 or an inertial unit 422 associated with a geolocation device 421. The backup step E7 is implemented if the loss of sources of information including the loss of the or all of the anemo-barometric sensors 41 and of the speed estimator 52 is detected in the surveillance step E1.

The piloting aid method and system thus make it possible to increase the availability of the automatic guidance devices of the aircraft AC while conserving maximum operational capabilities of the automatic pilot 2 and of the thrust regulation device 3 according to the context of current anemometric failures.

It will also be noted that a current automatic pilot 2 and thrust regulation device 3 contain a significant number of different guidance modes which each correspond to an objective that the crew can select as a function of its intentions. Learning these different guidance modes and their transitions represents a not inconsiderable part of the training of the crews. Also, the introduction of new guidance modes for the automatic pilot and/or the thrust regulation device entails, in general, a new learning phase, even ongoing training if this guidance mode can only be used in exceptional cases which, generally, are not encountered in normal use of the aircraft AC.

Thus, by virtue of an increased availability of the automatic pilot 2 and of the thrust regulation device 3 and by virtue of the preservation of their operational capability, the piloting aid method and system make it possible to preserve the continuity of the current operations or, at least, to propose basic functions.

The piloting aid method and system also make it possible to have increased assistance in the control of the aircraft AC and to lighten the workload of the crew of the aircraft AC and to allow it space to reinforce its activities of analysing and surveying the elements exhibiting a failure.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An automatic method for aiding in the piloting of an aircraft, making it possible to ensure the availability of at least an automatic pilot and/or a thrust regulation device which can be controlled as a function of an item of aircraft speed information, the automatic pilot corresponding to an automatic piloting system and/or a flight director, the aircraft speed information item being determined from one more sources of information, the automatic pilot and/or the thrust regulation device being configured to operate according to a first current guidance mode and an approach capability selected by a pilot of the aircraft included in a first set of selectable guidance modes and of selectable approach capabilities, the method comprising:
a surveillance step, implemented by a surveillance module, including being able to detect the loss of one or more of said one or more sources of information making it possible to determine the item of aircraft speed information;
in case of detection of a loss of at least one information source, the method further comprising:
a first determination step, implemented by a determination module, including choosing a second predetermined set of selectable guidance modes and of selectable approach capabilities as a function of the information source or sources whose loss was detected in the surveillance step, the second set being a subset of the first set;
a first step of use, implemented by a using module, including making the automatic pilot and/or the thrust regulation device operate according to a second current guidance mode and an approach capability forming part of the second set.

2. The method according to claim 1, wherein the first set also comprises a first state machine configured to manage transitions to switch from one guidance mode out of the guidance modes of the first set to another guidance mode out of the guidance modes of the first set,
the first step also including determining a second state machine configured to manage transitions to switch from one guidance mode out of the guidance modes of the second set to another guidance mode out of the guidance modes of the second set.

3. The method according to claim 1, wherein:
when the first current guidance mode forms part both of the first set and of the second set, there is no change of guidance mode;
when the first current guidance mode does not form part of the second set, there is a change of guidance mode to a predetermined guidance mode, forming part of the second set.

4. The method according to claim 1, wherein, after the detection of a loss of at least one source of information, the surveillance step continues to be implemented by the surveillance module,
in case of detection of the end of loss of the source or sources of information in the surveillance step, the surveillance step (E1) is followed:
by a second step of use, implemented by the using module, including making the automatic pilot and/or the thrust regulation device operate according to a current guidance mode and an approach capability forming part of the first set,
in case of detection of the loss of at least one other source of information in the surveillance step, the surveillance step is followed:
by a second determination step, implemented by the determination module, including modifying the second set of selectable guidance modes and of selectable approach capabilities as a function of the source or sources of information whose loss was detected in the surveillance step,
a third step of use, implemented by the using module, including making the automatic pilot and/or the thrust regulation device operate according to a third current guidance mode and an approach capability included in the modified second set.

5. The method according to claim 1, wherein the sources of information surveyed in the surveillance step comprise at least one anemo-barometric sensor and at least one speed estimator.

6. The method according to claim 1, wherein the method comprises a backup step, implemented by a backup module, including determining an altitude and a vertical speed by using a source of auxiliary information comprising a geolocation device or an inertial unit associated with a geolocation device, the backup step being implemented if the loss of source of information including the loss of the or all of the anemo-barometric sensors and of the speed estimator is detected in the surveillance step.

7. The method according to claim 1, wherein the guidance modes are included among:
the following lateral guidance modes:
a heading tracking mode,
a route tracking mode,
a flight plan-based navigation mode,
an approach beam lateral capture mode),
a localizer approach beam lateral tracking mode,
a virtual approach beam lateral capture mode of a navigation system of the aircraft,
a virtual approach beam lateral tracking mode of the navigation system;
the following vertical guidance modes:
a vertical speed holding mode,
a flight path angle holding mode,
an altitude capture mode,
an altitude maintaining mode,
a post-take-off climb or go-around mode,
a climb with constant thrust or speed maintaining mode,
a descent with constant thrust or speed maintaining mode,
a climbing vertical profile tracking mode,
a descending vertical profile tracking mode,
an air collision avoidance profile vertical tracking mode,
an approach beam vertical capture mode,
an approach beam vertical tracking mode,
a virtual approach beam vertical capture mode of the navigation system,
a virtual approach beam vertical tracking mode of the navigation system;
the following thrust regulation guidance modes:
a speed maintaining mode,
a Mach number maintaining mode,
a thrust maintaining mode.

8. The method according to claim 1, wherein the approach capabilities classified according to a decision height and a runway visual range are included among:
a first approach capability for which the decision height is greater than or equal to 200 feet and for which the runway visual range is greater than or equal to 2400 feet,
a second approach capability for which the decision height is greater than or equal to 100 feet and strictly less than 200 feet and for which the runway visual range is greater than or equal to 1000 feet,
a third approach capability for which the decision height is strictly less than 100 feet and for which the runway visual range is greater than or equal to 700 feet,
a fourth approach capability for which the decision height is greater than or equal to zero and strictly less than 50 feet and for which the runway visual range is greater than or equal to 250 feet and strictly less than 700 feet,
a fifth approach capability for which the decision height and the runway visual range are nil.

9. The method according to claim 1, wherein the sources of information comprise three anemo-barometric sensors and a speed estimator, the first set comprising all the guidance modes and all the approach capabilities.

10. The method according to claim 7, wherein, in the case where the loss of an anemo-barometric sensor is detected in the surveillance step, the second set determined in the first determination step corresponds to the first set.

11. The method according to claim 7, wherein, the sources of information comprising three anemo-barometric sensors and a speed estimator, in the case where the loss of two anemo-barometric sensors is detected in the surveillance step, the second set determined in the first determination step comprises all the guidance modes of the first set and the first approach capability.

12. The method according to claim 7, wherein, the sources of information comprising three anemo-barometric sensors and a speed estimator, in the case where the loss of the three anemo-barometric sensors is detected, the second set determined in the first determination step comprises at least:
the heading tracking mode,
the route tracking mode,
the approach beam lateral capture mode,
the approach beam lateral tracking mode,
the vertical speed holding mode,
the flight path angle holding mode,
the altitude capture mode,
the altitude maintaining mode,
the post-take-off climb or go-around mode,
the climb with constant thrust or speed maintaining mode,
the descent with constant thrust or speed maintaining mode,
the approach beam vertical capture mode,
the approach beam vertical tracking mode,
all the thrust regulation guidance modes,
the first approach capability.

13. The method according to claim 7, wherein, the sources of information comprising three anemo-barometric sensors and a speed estimator, in the case where the loss of the three anemo-barometric sensors and of the speed estimator is detected, the second set determined in the first determination step comprises at least:
the heading tracking mode,
the route tracking mode,
the vertical speed holding mode,
the flight path angle holding mode,
the thrust maintaining mode.

14. An automatic system for aiding in the piloting of an aircraft, making it possible to ensure the availability of at least an automatic pilot and/or a thrust regulation device which can be controlled as a function of an item of aircraft speed information, the automatic pilot corresponding to an automatic piloting system and/or a flight director, the item of aircraft speed information being determined from one or more sources of information, the automatic pilot and/or the thrust regulation device being configured to operate according to a first current guidance mode and an approach capability selected by a crew of the aircraft included in a first set of selectable guidance modes and of selectable approach capabilities,
the system comprising:
a surveillance module configured to detect the loss of one or more of said one or more sources of information making it possible to determine the speed of the aircraft,
a determination module configured to choose a second predetermined set of selectable guidance modes and of selectable approach capabilities as a function of the source or sources of information whose loss was detected by the surveillance module, the second set being a subset of the first set, and
a first using module configured to make the automatic pilot and/or the thrust regulation device operate according to a second current guidance mode and an approach capability included in the second set;
the determination module and the first using module being implemented in case of the detection of a loss of at least one source of information.

15. An aircraft, comprising a piloting aid system according to claim 14.
